(19) United States
(12) Patent Application Publication
(10) Pub. No.: US 2010/0013214 A1
(43) Pub. Date: Jan. 21, 2010

(54) Integral 90 Degree Fitting Hydraulic Quick Coupler and Attachments and Work Machines Employing the Same

(75) Inventors: Michael Lee Vought, Grove City, MN (US); Matthew Ryan Kettner, Litchfield, MN (US); Jeremy Allen Amundson, Willmar, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: CLARK EQUIPMENT COMPANY, West Fargo, ND (US)

(21) Appl. No.: 12/505,134

(22) Filed: Jul. 17, 2009

Related U.S. Application Data
(60) Provisional application No. 61/081,815, filed on Jul. 18, 2008.

(51) Int. Cl. F16L 37/00; A01D 82/00

(52) U.S. Cl. 285/33; 56/1

(57) ABSTRACT

A hydraulic quick coupler for coupling hydraulic hoses of an attachment to a work machine includes a cylindrical quick release coupler end portion configured to mate with another quick coupler to form a sealed hydraulic connection. A middle portion of the quick coupler is connected to the end portion and provides a fluid path to the end portion. An integral 90° elbow of the quick coupler includes a threaded end providing a threaded connection to the middle portion, a flare style coupler end for coupling to a fitting of a hydraulic hose, and a 90° bend section connected between the threaded end and the flare style coupler. The 90° bend section provides a fluid path between the threaded end and the flare style coupler and is configured to redirect hydraulic fluid flow by 90°.

### CROSS-REFERENCE TO RELATED APPLICATION

The present application is based on and claims the benefit of U.S. provisional patent application Ser. No. 61/081,815, filed Jul. 18, 2008, the content of which is hereby incorporated by reference in its entirety.

### BACKGROUND OF THE INVENTION

In work machines such as skid steer loaders, track loaders, excavators, utility vehicles and the like, the vehicles are typically driven using hydraulic power. For illustrative purposes, these work machines are discussed using a loader as an example. Various implements or attachments can be removably attached to the loader to perform specific functions. A few of the many examples of these various attachments include buckets, blades, stump grinders, excavation arms, lawn mowers, and snow blowers. Often, these attachments also require hydraulic power to perform their intended function.

Providing hydraulic power to attachments of a loader typically requires the connection and routing of hydraulic hoses from the attachment to the hydraulic system of the loader. Typically, the attachment to hydraulic hoses of the loader is done with quick release couplers. The quick release couplers are typically of the flush face male and female coupler variety. In many instances, different hoses on an attachment will have different ones of the male and female coupler types, and the hoses on the loader will have the appropriate type of componentry to mate with the correct hoses, so that the hoses from the attachment aren't connected incorrectly to the hydraulic system of the loader.

Typical quick release hydraulic couplers are cylindrical with threads on their back side to form an O-ring boss seal connection. In order to aid in routing the hydraulic hoses, minimizing space required to create clearance for the operation of the loader and attachment, etc., it is often desired to implement a 90° turn of the hydraulic hose relative to the direction of flow at the male/female end of the quick coupler. To implement this 90° turn, an extra 90° fitting is threaded onto the back side of the coupler. The quick coupler and extra fitting together can take up more room than desired, making routing of the hydraulic hoses more difficult, and leaving less clearance for loader and attachment operation than may be desired.

The discussion above is merely provided for general background information and is not intended to be used as an aid in determining the scope of the claimed subject matter.

### SUMMARY OF THE INVENTION

Disclosed embodiments provide various integral 90° fitting hydraulic quick coupler designs which can be used to connect and disconnect the hydraulic hoses of an attachment to the hydraulic system of a loader or other work machine. The integral 90° fitting hydraulic quick coupler designs can be used to connect the hydraulic system and route the hydraulic hoses, while providing additional clearance for machine and attachment operation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1-1 is a perspective view of a female flush face coupler in accordance with an example embodiment.

FIG. 1-2 is a top view of the female flush face coupler shown in FIG. 1-1.

FIG. 1-3 is a side view of the female flush face coupler shown in FIG. 1-1.

FIG. 1-4 is an end view of the female flush face coupler shown in FIG. 1-1.

FIG. 2-1 is a perspective view of a male flush face coupler in accordance with an example embodiment.

FIG. 2-2 is a top view of the male flush face coupler shown in FIG. 2-1.

FIG. 2-3 is a side view of the male flush face coupler shown in FIG. 2-1.

FIG. 2-4 is an end view of the male flush face coupler shown in FIG. 2-1.

FIG. 3 is a perspective view showing how male and female ends of the couplers shown in FIGS. 1 and 2 could mate to form a hydraulic connection.

FIG. 4-1 is a side view of another embodiment of a female flush face coupler.

FIG. 4-2 is another side view of the female flush face coupler shown in FIG. 4-1.

FIG. 5 is an illustration of a portion of an attachment and a portion of a loader, with flush face couplers, in accordance with disclosed embodiments, on the attachment hoses hydraulically connecting the attachment to appropriate male and female connectors of a special casting or other coupling component on the loader.

FIG. 6 is another illustration of the flush face couplers and coupling component shown in FIG. 5.

### DETAILED DESCRIPTION OF ILLUSTRATIVE EMBODIMENTS

Disclosed are various embodiments of integral 90° fitting hydraulic quick couplers which allow quick release hydraulic coupling of the hoses on an attachment to a loader (or other work machine) in a manner which requires less space, and therefore provides for more convenient routing of hoses and for more operational clearance for the loader and attachment.

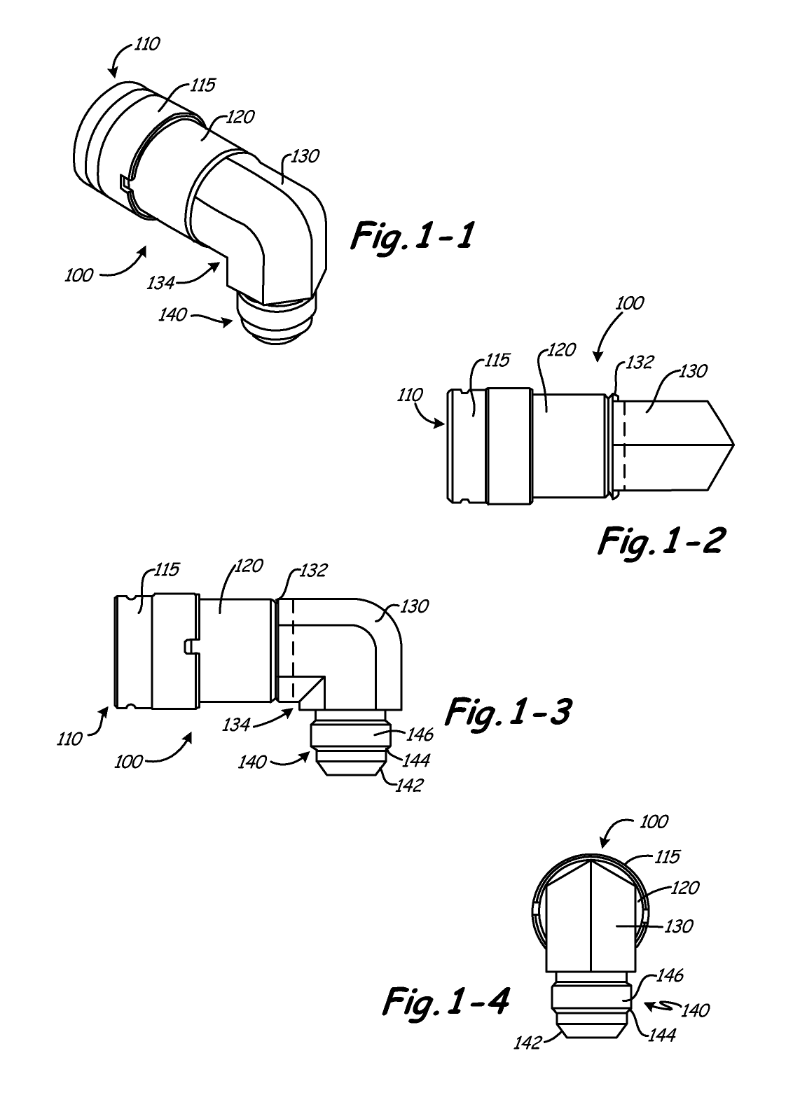

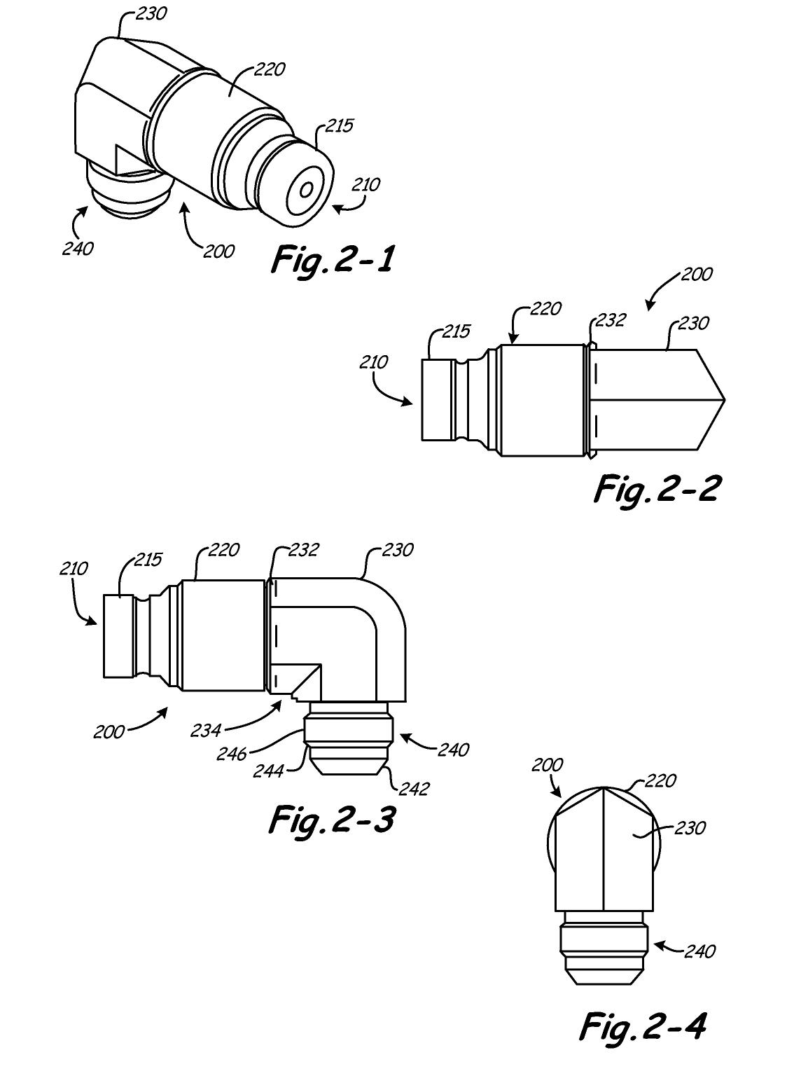

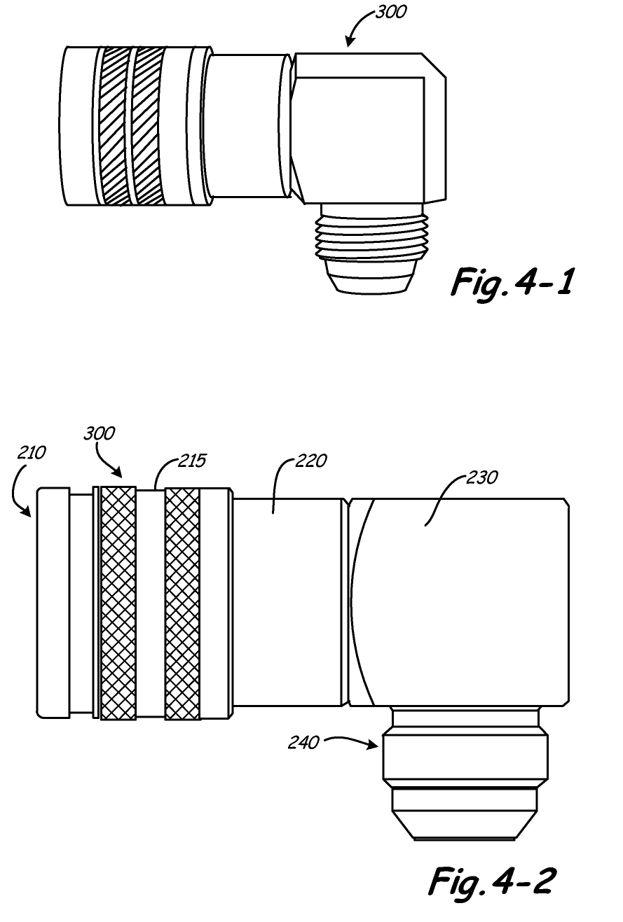

FIGS. 1-1 through 1-4 are views of a female flush face coupler 100 in accordance with an example embodiment. Female flush face coupler 100 is an integral 90° fitting hydraulic quick coupler which performs functions which have conventionally required a cylindrical quick release flush face coupler and a separate 90° fitting threaded onto the back side of the coupler. This provides a space savings which allows for better routing of hoses.

Flush face coupler 100 has a quick couple end 110 of a conventional type which mates with a male coupler component on a loader or other work machine. As in a conventional style of quick coupler, end 110 includes an outer sleeve 115 configured to receive a male coupler to form a sealed connection. To release the connection, sleeve 115 is slid back over portion 120. Springs, seals and other internal components which aid in this functionality are interior to sleeve 115 and portion 120, and are therefore not illustrated. These inner components are well known in the art for this type of coupler.

Flush face coupler 100 also includes an integral 90° elbow 130. Integral 90° elbow or fitting 130 has a threaded end 132 which allows a threaded connection to middle portion 120 of quick couple end 110. In conventional quick couplers, an O-ring boss seal connection has been formed with portion 120. A straight or 90° converting section has then previously been used to convert from the O-ring boss to a JIC (Joint Industrial Council) nipple. This causes the overall device to increase in length, creating the routing and clearance issues discussed above. Integral 90° elbow or fitting 130 helps to overcome these issues.

Integral 90° fitting 130 has, at the end opposite threaded end 132, an integral JIC nipple 140 or other 37° flare style coupler. The JIC nipple 140 can be, for example, a JIC-12 threaded nipple, a JIC-8 threaded nipple, a JIC-6 threaded nipple, etc. Between nipple 140 and threaded end 132, fitting 130 has a 90° bend 134 to redirect hydraulic fluid flow. Nipple 140 has tapered portions 142 and 144 and a threaded portion 146 (individual threads not shown). In a conventional manner, JIC nipple 140 is secured to the end of a hydraulic hose of the attachment using a fitting crimped onto the hose. The fitting has internal threads, and it acts as the female portion to the male threaded portion 146 of the JIC nipple. When the female internally threaded fitting on the hose is screwed onto the threaded portion 146 of the JIC nipple 140, tapered portions (e.g., tapered portions 142 and 144) on both the fitting and the JIC nipple come together to prevent leaks. Threaded portion 146 can have any size of desired threads (e.g., ¾″, ⅜″, etc.).

Integral 90° fitting 100 is integral in the sense that the flush face quick coupler 110, the 90° bend 134 and the nipple portion 140 are assembled and used as a single component, without the need to attach an O-ring-boss to a JIC nipple converter. However, the term “integral” does not imply that a single continuous material is used throughout, that there are not internal and/or external components made from different materials, etc. For flush face coupler 100, much of the device can be made of cast steel or other materials. Internally, coupler 100 will typically have springs and other machined components, rubber seals, etc.

Referring now to FIGS. 2-1 through 2-4, shown are views of a male flush face coupler 200 in accordance with an example embodiment. Male flush face coupler 200 is substantially the same as female flush face coupler 100, but with male coupler components instead of female coupler components. As such, the components of male flush face coupler are similarly numbered (e.g., 120 and 220, etc.) with their corresponding parts from FIGS. 1-1 through 1-4.

Flush face coupler 200 has a quick couple end 210 of a conventional type which mates with a female quick coupler connector on a loader or other work machine. As in a conventional style of quick coupler, end 210 includes a male coupler component 215 configured to be received by a female coupler to form a sealed connection. A middle portion 220 is positioned between male coupler component 215 and integral 90° elbow 230. Integral 90° elbow or fitting 230 has a threaded end 232 which allows a threaded connection to portion 220 of quick couple end 110.

Integral 90° fitting 230 has, at the end opposite threaded end 232, an integral JIC nipple 240 or other 37° flare style coupler. Between nipple 240 and threaded end 232, fitting 230 has a 90° bend 234 to redirect hydraulic fluid flow. Nipple 240 has tapered portions 242 and 244 and a threaded portion 246 (individual threads not shown). In a conventional manner, JIC nipple 240 is secured to the end of a hydraulic hose of the attachment using a fitting crimped onto the hose. The fitting has internal threads, and it acts as the female portion to the male threaded portion 246 of the JIC nipple. When the female internally threaded fitting on the hose is screwed onto the threaded portion 246 of the JIC nipple 240, tapered portions (e.g., tapered portions 242 and 244) on both the fitting and the JIC nipple come together to prevent leaks. Threaded portion 246 can have any size of desired threads (e.g., ¾″, ⅜″, etc.).

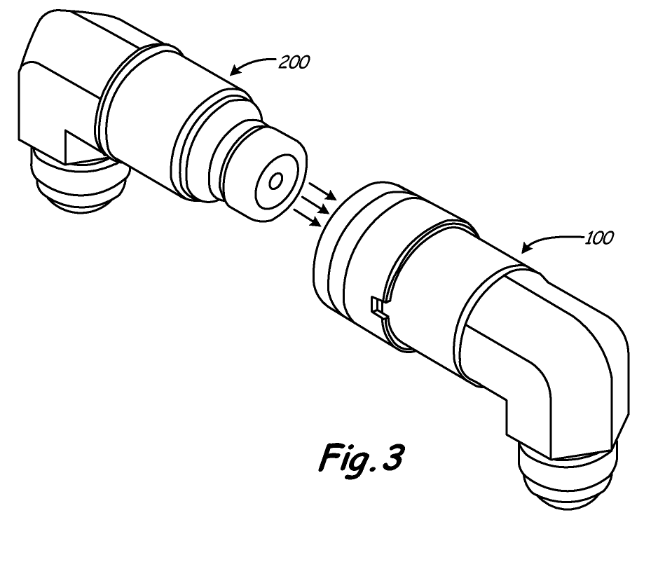

FIG. 3 is an illustration showing how female flush face coupler 100 and male flush face coupler 200 can be connected. It should be noted, however, that flush face couplers 100 and 200 need not be connected to each other. Very often, on the loader or other work machine, the quick release couplers 100 and 200 will be attached to hoses of the attachment, while a special casting or other coupling component having male and female connectors is attached to the loader. Thus, couplers 100 and 200 would both be used on different hoses of the attachment, but would not necessarily be used on the loader hoses.

Referring now to FIGS. 4-1 and 4-2, shown are side views of another embodiment of a female flush face coupler 300, similar to coupler 100 shown in FIG. 1. Female flush face coupler 300 is substantially the same as female flush face coupler 100, but with a slightly different 90° fitting section 230 appearance. As such, the components of female flush face coupler 300 are similarly numbered with their corresponding parts from FIGS. 1-1 through 1-4. Since couplers 100 and 300 are substantially the same with a slight appearance difference, a detailed discussion of coupler 300 is not provided.

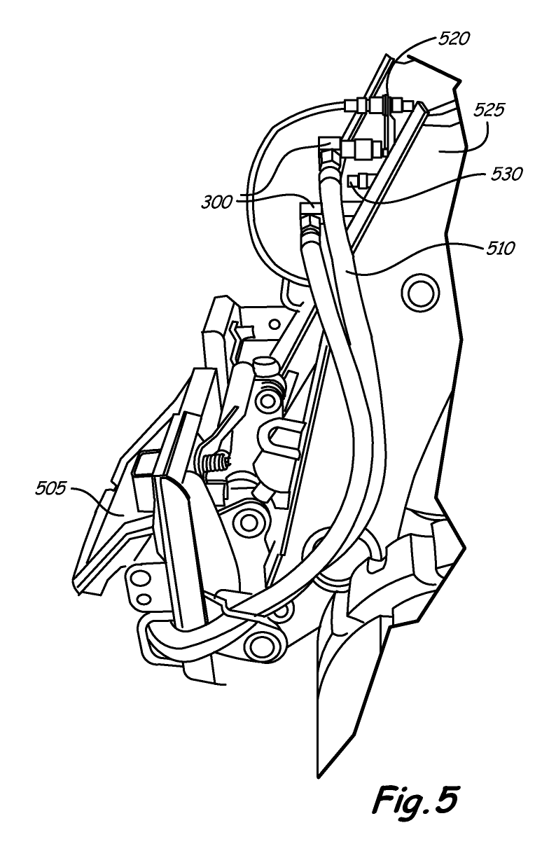

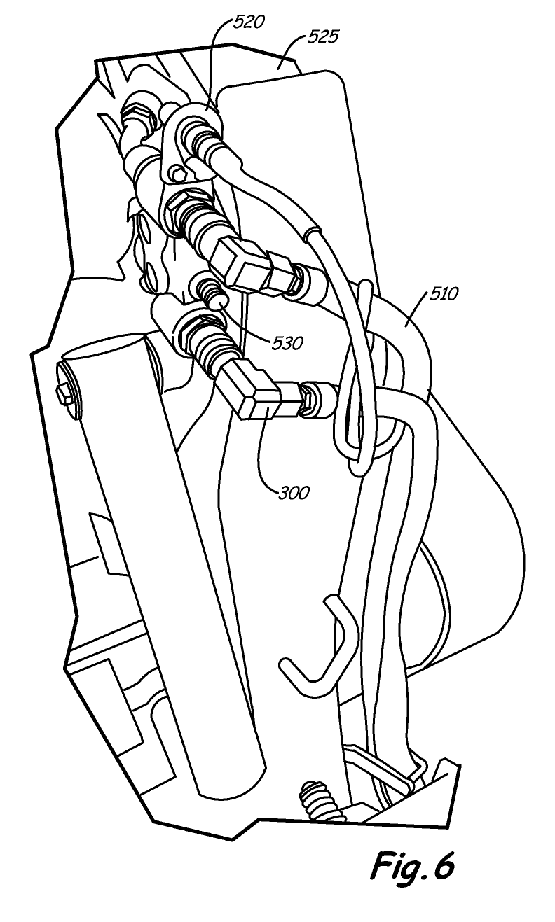

Referring now to FIGS. 5 and 6, shown are illustrations of female flush face couplers 300 in use. Couplers 300 are attached to the ends of hoses 510 of an attachment 505. The couplers 300 provide a quickly detachable sealed connection to the hydraulic system of loader 525 by coupling to male components 530 on a special casting or other coupling component 520 mounted to the loader 525.

Although the present invention has been described with reference to preferred embodiments, workers skilled in the art will recognize that changes may be made in form and detail without departing from the spirit and scope of the invention.

What is claimed is:

1. A hydraulic quick coupler for coupling hydraulic hoses to a work machine, the hydraulic quick coupler comprising:
a cylindrical quick release coupler end portion configured to mate with another quick coupler to form a sealed hydraulic connection;
a middle portion connected to the end portion and providing a fluid path to the end portion;
an integral 90° elbow comprising a threaded end providing a threaded connection to the middle portion, a flare style coupler end for coupling to a fitting of a hydraulic hose, and a 90° bend section connected between the threaded end and the flare style coupler, the 90° bend section providing a fluid path between the threaded end and the flare style coupler and configured to redirect hydraulic fluid flow by 90°.

2. The hydraulic quick coupler of claim 1, wherein the integral 90° elbow and the middle portion are configured to form a threaded connection without an O-ring boss seal connection formed between the 90° elbow and the middle portion.

3. The hydraulic quick coupler of claim 1, wherein the hydraulic quick coupler is a female flush face coupler.

4. The hydraulic quick coupler of claim 3, wherein the cylindrical quick release coupler end portion includes a sleeve which is configured to receive a male quick coupler to form the sealed hydraulic connection, the sleeve being configured to be slid over the middle portion to release the sealed hydraulic connection.

5. The hydraulic quick coupler of claim 1, wherein the hydraulic quick coupler is a male flush face coupler.

6. The hydraulic quick coupler of claim 5, wherein the cylindrical quick release coupler end portion includes a male coupler component configured to be received by a female coupler to form the sealed hydraulic connection.

7. The hydraulic quick release coupler of claim 1, wherein the flare style coupler end comprises first and second tapered portions and a threaded portion, the flare style coupler being securable to the fitting of the hydraulic hose by the threaded portion, and wherein when secured to the fitting of the hydraulic hose the first and second tapered portions preventing leaks of hydraulic fluid.

8. A work machine comprising:
a quick coupler component secured to the work machine;
a hydraulically driven attachment mounted on the work machine;
a hydraulic hose providing hydraulic fluid to the hydraulically driven attachment; and
a hydraulic quick coupler coupling the hydraulic hose to the quick coupler component secured to the work machine, the hydraulic quick coupler comprising:
a cylindrical quick release coupler end portion configured to mate with the quick coupler component secured to the work machine to form a sealed hydraulic connection;
a middle portion connected to the end portion and providing a fluid path to the end portion;
an integral 90° elbow comprising a threaded end providing a threaded connection to the middle portion, a flare style coupler end for coupling to a fitting of the hydraulic hose, and a 90° bend section connected between the threaded end and the flare style coupler, the 90° bend section providing a fluid path between the threaded end and the flare style coupler and configured to redirect hydraulic fluid flow by 90° to reduce space required to route the hydraulic hose.

9. The work machine of claim 8, wherein the integral 90° elbow and the middle portion are configured to form a threaded connection without an O-ring boss seal connection formed between the 90° elbow and the middle portion.

10. The work machine of claim 8, wherein the hydraulic quick coupler is a female flush face coupler.

11. The work machine of claim 10, wherein the cylindrical quick release coupler end portion includes a sleeve which is configured to receive the quick coupler component secured to the work machine to form the sealed hydraulic connection, the sleeve being configured to be slid over the middle portion to release the sealed hydraulic connection.

12. The work machine of claim 8, wherein the hydraulic quick coupler is a male flush face coupler.

13. The work machine of claim 12, wherein the cylindrical quick release coupler end portion includes a male coupler component configured to be received by the quick coupler component secured to the work machine to form the sealed hydraulic connection.

14. The hydraulic quick release coupler of claim 8, wherein the flare style coupler end comprises first and second tapered portions and a threaded portion, the flare style coupler being securable to the fitting of the hydraulic hose by the threaded portion, and wherein when secured to the fitting of the hydraulic hose the first and second tapered portions preventing leaks of hydraulic fluid.
